(19) United States
(12) Patent Application Publication
(10) Pub. No.: US 2015/0112839 A1
(43) Pub. Date: Apr. 23, 2015

(54) ONLINE SHOPPING SYSTEM AND METHOD

(71) Applicant: Concept Marketing Pty Ltd, Perth, WA (AU)

(72) Inventors: Mark Da Silva, Perth (AU); George Rebelo, Perth (AU); Thushara Weerakody, Perth (AU)

(21) Appl. No.: 14/397,039

(22) PCT Filed: Apr. 26, 2013
(86) PCT No.: PCT/AU2013/000431

§ 371 Date: Oct. 24, 2014

(30) Foreign Application Priority Data
Apr. 26, 2012 (AU) 2012100485

(51) Int. Cl. G06Q 30/06

(52) U.S. Cl. CPC G06Q 30/0623
USPC 705/26.61

(57) ABSTRACT

An online shopping platform (11) adapted for the repetitive purchase of a class of products by Customers (32) from a designated Grocer (36) comprising a computer system having database facilities and being connected to the internet, wherein the platform (11) maintains a list of products (38) available for purchase from selected major retailers and wherein the price of each product being offered by the selected major retailers is ascertained and recorded on a recurring basis to thereby determine a lowest price for each product within an identified region in order to offer products to Customers (32) located in particular identified regions a price-matched price not higher than the lowest price being offered by any of the selected major retailers in that particular identified region.

### FIELD OF THE INVENTION

The present invention relates to a system and method of purchasing goods and the like. More particularly, the invention concerns a system for purchasing goods over the internet.

### BACKGROUND ART

With the advent and expansion of the internet, there has been a tremendous growth in the sale of goods online. Now most sellers of goods and services promote their produce via a “Web Site”. Potential customers have become accustomed to reviewing Web Sites of competing traders to find the most desirable deal. Obviously, price is a prime criterion in any purchase and shoppers may be prepared to peruse many Web Sites when the cost of the item is high in order to find the lowest price. However, the time spent visiting sites can be considerable, and is often not justified for items of small value. This is particularly so in the case of products such as groceries available from supermarkets and the like where the price per item is low but the customer is usually interested in purchasing many different products in a single purchasing event. As well the price of such products is changed frequently and also subject to “Specials”—being offered a very low price to attract customers. Now, major supermarket chains offer online shopping, but price comparison between chains is still cumbersome as products must be identified either by typing the product name or selecting from an extended list, one by one, in each chain's web site. This is extraordinarily time consuming and would only be attempted by the most diligent customer. In addition it would not normally be worth ordering some goods from one of the chains and other from the major competitor, as the chains charge a delivery fee and the potential savings would be lost in having to pay more than one delivery fee.

Certain prior art web based price comparison systems have been disclosed previously. An example of this is disclosed in International publication WO2001097143. This discloses a system for a unified product purchasing service and order injection system. This system is directed to a shopping service that obtains products for a customer across many different merchant and supplier sites while maintaining a consistent user interface for the customer no matter which merchant provides the products. In particular, the present invention allows a customer to search for, compare prices and order products from many different merchants located on the Internet. The customer completes their shopping on the shopping site provided by the present invention and is not directed to another merchant's site to complete an order. While there is similarity between the objects and outcomes of the system disclosed in WO2001097143 and those of the present invention, there are limitations in this prior art. The present invention provides advantages which are not disclosed in the prior art. These are discussed in greater detail below.

Another disclosure, U.S. Pat. No. 7,305,355 (TARVYDAS et. al.), is directed to purchasing items from multiple vendors directly through a common internet portal. This discloses a shopping cart that obtains and orders products and services from different merchants located on the Internet. It creates accounts on merchant sites without user intervention but the purchases are made from the various separate merchants. The disclosure of WO2001027837 (Chachra et. al.), provides a method of facilitating online shopping from various vendors. The Customer is directed to different retailer sites and enables online purchases from multiple retailers. Both of these references disclose systems wherein a Customer using the systems actually purchases products from different retailers. In this regard they are very similar to the disclosure of WO2001097143 discussed above.

The discussion of the background art, any reference to a document and any reference to information that is known, which is contained in this specification, is provided only for the purpose of facilitating an understanding of the background art to the present invention, and is not an acknowledgement or admission that any of that material forms part of the common general knowledge in Australia or any other country as at the priority date of the application in relation to which this specification was filed.

The headings in this specification are provided for convenience to assist the reader, and they are not to be interpreted so as to narrow or limit the scope of the disclosure in the description, claims, abstract or drawings.

### DISCLOSURE OF THE INVENTION

Accordingly, the invention resides in an online shopping platform for the repetitive purchase of a class of products by Customers from a designated Grocer comprising a computer system having database facilities and being connected to the internet, wherein the platform maintains a list of products available for purchase from selected major retailers and wherein the price of each item being offered by the selected major retailers is ascertained and recorded on a recurring basis to thereby determine a lowest price for each product within an identified region in order to offer products to Customers located in particular identified regions a price-matched price not higher than the lowest price being offered by any of the selected major retailers in that particular identified region.

According to a preferred feature of the invention, the right to sell products to customers in a particular identified region at the price-matched price is provided to a designated Grocer for a fee for a predetermined period.

According to a preferred feature of the invention, the designated Grocer is provided the order list and payment by the platform after an order is placed by a customer in the particular identified region.

According to a preferred feature of the invention, a right to market alternative products similar to certain products selected by a Customer is provided to a Supplier for a pre-determined period for a fee.

According to a preferred feature of the invention, the Supplier identifies products of its competitors listed on the platform and links his products to the competitors' products to enable the platform to offer his products for sale to a customer when the customer selects a competitor's product.

According to a preferred feature of the invention, the platform stores a record of all purchases by customers in the database to customer purchasing information to be obtained by analysis of the customer's purchases.

According to a preferred feature of the invention, the customer purchasing information is used to enable marketing reports for a particular identified region to be generated and provided to Suppliers and Grocers.

According to a preferred feature of the invention, the customer purchasing information is used to enable Suppliers to direct advertisements to customers in a targeted and personalized manner.

According to a preferred feature of the invention, the customer purchasing information is used to enable Grocers to direct advertisements to customers in a targeted and personalized manner.

According to a preferred feature of the invention, the customer identifies the product to be selected for purchase by scanning the barcode of the same product which the customer has obtained previously.

According to a further aspect, the invention resides in an online shopping method adapted for the repetitive online purchase of a class of products by Customers wherein a Customer access an online shopping platform and selects one or more products for purchase, the platform being operated and maintained by an Operator, the platform comprising a computer system having database facilities and being connected to the internet, wherein the platform maintains a list of products available for purchase from selected major retailers and wherein the price of each item being offered by the selected major retailers is ascertained and recorded on a recurring basis to thereby determine a lowest price for each product within an identified region in order to offer products to Customers located in particular identified regions a price-matched price not higher than the lowest price being offered by any of the selected major retailers in that particular identified region and wherein the price-matched price is displayed for viewing by the customer for the products selected wherein the customer completes the purchase and pays for the purchase by payment means, and wherein the selected products are provided to the Customer by a designated Grocer within the particular identified region, the Grocer being selected by the Operator for agreeing with the Operator to provide the products to customers at the price-matched price.

The invention will be more fully understood in the light of the following description of several preferred embodiments.

### BRIEF DESCRIPTION OF THE DRAWINGS

The description is made with reference to the accompanying drawings, of which:

FIG. 1 is a diagrammatic representation of a computer server according to the embodiment;

FIG. 2 is a diagrammatic representation of a “Cloud” adaptation of the computer server of the embodiment;

FIG. 3 is a diagrammatic representation of the parties interacting with the computer server of the embodiment;

FIG. 4 is a further diagrammatic representation of FIG. 3 indicating the flow of information between the parties and the server;

FIG. 5 is a representation of the data table for location data for the database of the embodiment;

FIG. 6 is a representation of the data table for product data for the database of the embodiment;

FIG. 7 is a representation of the data table for purchase data for the database of the embodiment;

FIG. 8 is a representation of the data table for Grocer products data for the database of the embodiment;

FIG. 9 is a representation of the data table for product categories data for the database of the embodiment;

FIG. 10 is a representation of the data table for data about an individual for the database of the embodiment.

### DETAILED DESCRIPTION OF PREFERRED EMBODIMENTS

The shopping platform of the invention is an internet-based product marketplace bringing together private individuals and presenting them with a choice and pricing for products available for online purchase. The platform is particularly applicable to the online purchasing of groceries where the same or similar products are purchased repetitively over a period of time. However it is not limited to this application.

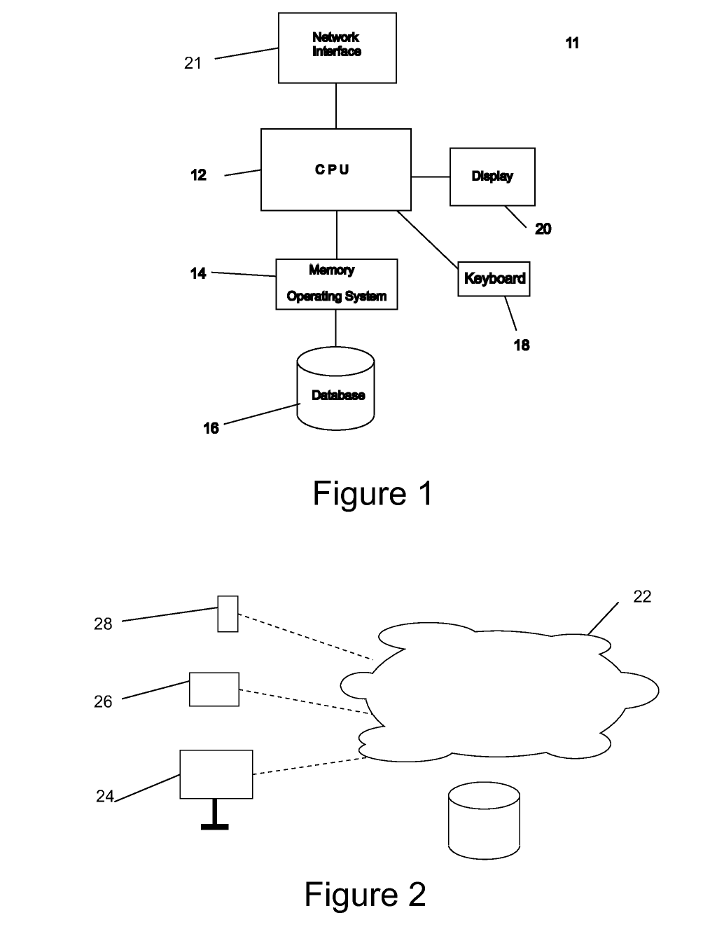

The first embodiment of the invention is directed to an online shopping platform which provides the customer with convenience by virtue of a single and consistent interface as well as means for obtaining best price. The elements of the platform are shown in FIGS. 1 to 4.

In example embodiments, a computer system (e.g., a standalone, client or server computer system) configured by an application may constitute a “platform” or “module” that is configured and operates to perform certain operations In other embodiments, the “platform” or “module” may be implemented mechanically or electronically; so a platform or module may comprise dedicated circuitry or logic that is permanently configured (e.g., within a special-purpose processor) to perform certain operations. A platform or module may also comprise programmable logic or circuitry (e.g. as encompassed within a general-purpose processor or other programmable processor) that is temporarily configured by software to perform certain operations. It will be appreciated that the decision to implement a platform or module mechanically, in the dedicated and permanently configured circuitry, or in temporarily configured circuitry (e.g. configured by software) may be driven by cost and time considerations. Accordingly, the term “module” or “platform” should be understood to encompass a tangible entity, be that an entity that is physically constructed permanently configured (e.g., hardwired) or temporarily configured (e.g., programmed) to operate in a certain manner and/or to perform certain operations described herein.

As shown in FIG. 1, the core of the physical system comprises a centralized computer server 11. The server comprises the usual elements including central processing unit 12, memory 14, data storage module 16, input module 18 and output module 20 and communication module 21 in the form of network access to the internet. Those skilled in the art will realize that for a computer system of the power and data storage required, the system will preferably comprise a plurality of interconnected sub-systems which together implement the functions required to constitute the complete system. They will also be aware that components need not necessarily be located in one physical location. In an adaptation of the system the server is provided by cloud computing resources as represented in FIG. 2.

The server 11 will execute programs or software which are the core of the platform enabling the server to interact with the various entities of the platform as described below.

The server is provided by the Operator of the platform and operated and maintained by the Administrator of the platform and subordinate employees.

### Employee Capabilities

### System Administrators:

Provide overall management of the platform
Notify of security violations.
Enable system administrators to generate security violation reports.

### Customer Support Staff

Enable the creation, modification and deletion of user accounts. Enable resetting of user passwords.

### Stock Management Staff

Audit suppler uploaded stock information and pricing.
Allow the importing of stock lists comprising Item, Description, SKU, Barcode, and Image.
Allow the creation modification and deletion of stock items
Allow the entry of search meta data to allow product matching and searches.

### Employee Functions

Notify of security violations.
Enable system administrators to generate security violation reports.
Enable the creation, modification and deletion of user accounts.
Enable the resetting of user account passwords.
Audit supplier uploaded stock information I pricing
Allow the importing of stock lists
Allow the creation, modification and deletion of stock items.
Allow the entry of search meta data to allow product matching and searches

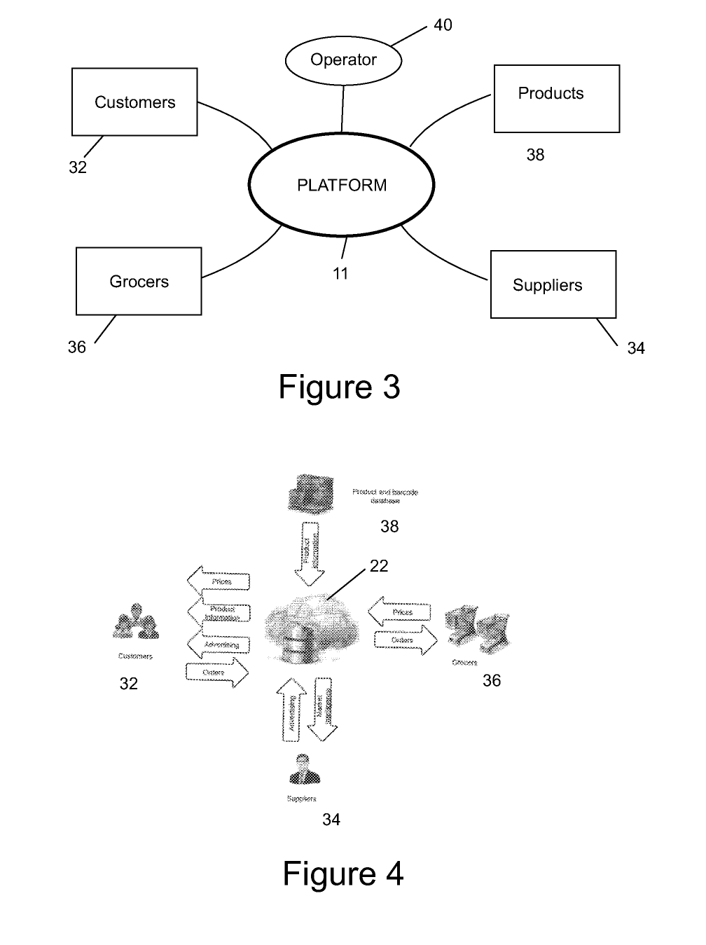

The interconnection of the server with the various external parties is shown in FIG. 3. The server 11 is connected with Customers 32, Suppliers 34 and Grocers 36. Each of these parties interacts with the platform's database in their own manner. In addition the server scrapes for price data of products 38 of interest from designated online shopping systems of major supermarket chains. The operation is controlled by the Operator 40 by the System Administrator and employees. The interaction of the parties with the server is further represented in FIG. 4 which illustrates the flow of information.

An essential element of the platform is that it enables “Price-Match”, that is, it enables the platform to be able to compare the price offered by selected major retailers of the relevant products and determine the minimum. The database contains details of all products available from the selected major retailers which are, primarily, the major supermarket chains, including identifying number, description, picture and price. The price is updated on a regular basis by “price scraping”, that is using software that scans the internet to identify the relevant prices. Of particular significance is the fact that the platform identifies the price relative to particular areas or identified regions. It is known that supermarket chains vary their prices, both in stores and online, according to the location of the store or the customer. This takes account of variations in costs and overheads that must be taken into account in setting a retail price. The platform is directed to identifying the minimum price in a particular area or region, rather than an absolute minimum price nationally. Thus the price-match provided by the platform is locally based. The database also keeps a record of all transactions concerned with the platform. Again, this is discussed below.

### Customer Capabilities

The platform enables a customer to interact with the platform in a consistent, user friendly manner. The customer connects to the platform by a suitable interface device, such as a personal computer 24, a PDA, a smartphone (e.g. an iPhone (registered trade mark of Apple Inc.) or Android based device) 28 or a Tablet 26 which connects to the platform via the internet. Preferably, a barcode scanning means is associated with the interface device either as a separate barcode reading device or inherently with the interface device such as using a camera already associated with the device operating in conjunction with software or an “App” on the device.

When the customer accesses the platform for the first time he is required to register providing a unique username, a password, his name, address contact information and if deemed appropriate date of birth or other identifying information. The customer is then able to login and logout of the platform.

The customer may search for a product, or alternatively, identify a product using its name or identifying code. However, it has been recognized that identifying products each time by searching form them remains a relatively time consuming process. As mentioned previously, the platform is particularly applicable to the online purchasing of groceries where the same or similar products are purchased repetitively over a period of time. This aspect facilitates methods to speed up the process of identification of products based upon the fact that the customer has purchased the item previously. In one form, the purchaser is provided with a personal shopping list identifying a selected number, e.g. 20 or 50, products purchased over a predetermined period e.g. 3 months. This list is presented to the customer immediately after login. The customer can then select any of those products which he wishes to purchase on this occasion. After leaving this initial screen, the customer is taken to a product confirmation screen for each selected product successively. The product confirmation screen is the same as is used when a product is selected directly, and is described further below.

Preferably, the customer is provided with a barcode scanning means as previously discussed with which to scan the barcodes of products he has purchased previously and wishes to purchase again. The customer will enter a barcode scanning page of the web site and he will be asked to scan the item. After scanning, the customer is taken to the product confirmation page. This page will identify the product scanned, preferably displaying an image of the product held within the database and the price-matched price of the product. Optionally as determined by the administrator, there will also be displayed the price of the item at major chains (e.g. Coles and Woolworths—Coles is a registered trademark of Coles Supermarkets Australia Pty Ltd; Woolworths is a registered trademark of Woolworths Limited) and/or alternative items offered by Suppliers together with the price of those alternatives.

After confirmation, an item is added to the web site “shopping basket”, that is, the item is added to the list of products which the customer has identified in this particular shopping session.

As an alternative to barcode scanning, the customer can also search by product name or description. Once the product is identified and selected, the customer is again taken to the product confirmation page. The Customer will automatically be directed to the search page in the event that a scanned product is not available for purchase.

Once the customer has completed ordering products or otherwise to conduct an intermediate review, the customer can review the items in the “shopping basket” as a list of items selected, showing the price of each and the total cost. After confirming the list, the customer is taken to a payment page where he is able to pay for the goods selected. Payment is made in one of the normal online payment mechanisms such as credit card, debit card, direct debit from customer account, or other means established and maintained by the platform.

As mentioned above with reference to FIG. 2, the platform is accessed by Suppliers. Suppliers are parties that provide goods to retailers such as Grocers for sale in the area of the Customer that wish to have their products presented on the platform as an alternative to a product selected by a Customer. The platform thereby provides the Supplier with a means to market its products in a targeted manner depending upon criteria identified in respect of the Customer and especially his location.

### Supplier Capabilities.

Upon agreeing to the terms and conditions of the Operator to be a Supplier, the Supplier is able to register on the platform. The authorised officer of the Supplier provides a unique username, password, Supplier name, address, contact, billing information and other information required by the Operator in respect of the Supplier. The Supplier, through its officer, lists details of its products that it wishes to be displayed on the platform. It identifies its products as supplementary or complementary to other products that that are identifiable on the platform. It is given some option as to selecting a position to display the item, i.e. first choice, second choice etc. depending upon criteria provided by the operator. The Supplier is able to view purchase information about its products by various criteria such as Customer age, location etc.

The platform will generate invoices to suppliers on a routine time interval, e.g. monthly, for the charge being levied for the Supplier's advertising and placement.

The platform also allows Suppliers to directly advertise to potential shoppers and gain insight into the buying choices.

A distinguishing aspect of the invention as illustrated in the embodiment is its interaction with entities referred to as Grocers. Grocers are entities that actually provide products to Customers after the Customer has completed an order by means of the platform. Grocers purchase from the operator the rights to provide the products within an identified region or area, usually defined by one or more postcodes, at the price-matched price for that area for an agreed period, e.g. for one month. Typically, a Grocer is a smaller retailer in the identified region that is prepared to match the price-match price in order to obtain the right to supply Customers in its area. The platform thereby enables the Grocer to compete with the major supermarket chains in his identified region knowing that the price he is selling at is the price matched price for his identified region. The platform, by providing the price matched price, removes the substantial overhead for a small retailer or monitoring the prices of products being offered by the major chains in the identified region. The Grocer is thereby placed in a highly competitive position relative to the major competitors. The Grocer may charge a delivery charge not more than the delivery charge of the major supermarket chains. In this way the Grocer recovers his costs for home delivery in the same way that the supermarket chains do. However, the customer pays only a single delivery charge but is provided with all products at the price-matched price. In contrast, if the Customer purchased certain goods from one of the major supermarket chains and others goods from another of the major supermarket chains, the customer would need to pay more than one delivery charge which would likely nullify or at least substantially reduce any savings being made by seeking the lowest price.

### Grocer Capabilities

Upon agreeing to the terms and conditions of the Operator to be a Grocer, the Grocer is able to register on the platform. The authorised officer of the Grocer provides a unique username, password, Grocer name, address, contact, billing information and other information required by the Operator in respect of the Grocer. The Grocer is then able to log into the platform and subscribe to an identified region for Price-Match by identifying one or more postcodes, or otherwise as agreed with the Operator.

The platform captures and stores product information for all stocked items of the Grocer available for online shopping. The platform will offer for sale to Customers in a particular identified region only items available from the selected Grocer for the relevant period. When a Customer scans or searches a product that is not available from the Grocer, an alternative is displayed, in the manner previously discussed.

The platform forwards all relevant online orders to the designated Grocer on a regular basis, for the Grocer to fulfil. Payment is transferred for the goods in the agreed manner by the platform. On a regular basis, e.g. monthly, the Grocer is invoiced for its subscription to the Price Match service.

It will be appreciated that there will be a number of management related policy issues concerning the relationship between the Grocer and the Operator which can also be implemented on the platform. Issues such as whether a Grocer who has accepted to fulfil orders for a period can refuse to do so for a particular case need to be considered and the protocol for handling such issues determined. In more densely-populated areas, it may be appropriate to appoint more than one Grocer for a designated region for a particular period of time. The platform can then direct online orders from Customers to Grocers in turn according to range of predetermined criteria. This process may assist in the establishment of the commercial presence of the platform in the market place, by ensuring that several Grocers in an enlarged designated region all get some orders from the platform during the relevant period.

With the platform in place and the various parties registered and able to access the platform, a functional inter-relationship is established between the parties. The platform provides the functions to enable the functions to take place.

### Customer Functions:

Scan barcodes or otherwise identify items and see instant price comparison;
Scan barcodes or otherwise identify items and see detailed product information;
Scan barcodes or otherwise identify items and add to basket;
Search for products and add to basket;
View basket of items and see price comparison from major grocers;
Replace items or add complementary items to basket;
Order basket of items from selected grocer or split order to multiple grocers;
Review supplier sponsored supplementary or complementary items when viewing an item;
Place online order with selected grocer(s) or subscribed “Price Match” grocer selecting delivery and transferring payment details.

### The Basic Routine of Advertising Engine:

gather all available information about current event; keep only advertisements that include this event to their target;
rank advertisements according to their bids and their relevance to the event;
display (several) best ones;
compute discount (actual price for advertiser) when requested by the Customer.

### Supplier Functions

select item(s) as a supplementary or complementary for another item;
select position to display, i.e. 1st choice, 2nd choice;
view product purchase information by location, age for sponsored item(s);
provide fee based access to product purchase information by location, age for any selected complementary or competitive product;
present supplier sponsored supplementary or complementary items when customer views a related item;
produce a monthly invoice to supplier for advertising and placement; debit credit card for payment.

### Grocer Functions

register with the Platform providing username, password, name, grocer name, address, contact, billing information;
login and logout of the Platform account;
subscribe to a postcode for “Price Match”;
capture and store product and price information for all stock items available for online shopping;
send online order(s) to grocer, transferring delivery and payment details for subscribed “Price Match” postcodes;
produce a monthly invoice to grocer for “Price Match” postcode subscriptions;
debit credit card for payment.

It is to be noted that online major retailers such as Coles and Woolworths have different pricing based on postcode and as such the platform needs to capture the product prices for each product and postcode, preferably by the technique of scraping:
2,700 delivery area post codes (i.e. no PO boxes); combined number of products in Coles and Woolworths online Offering: 34,000

Therefore need to store, process and update approximately 91,800,000 product price/location data sets;

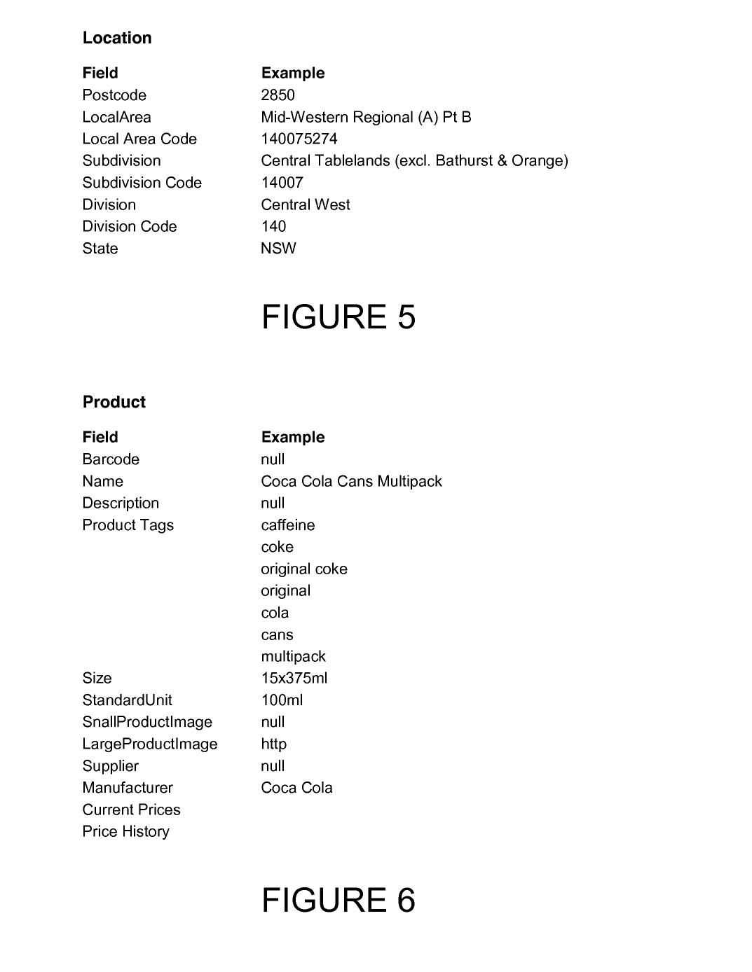

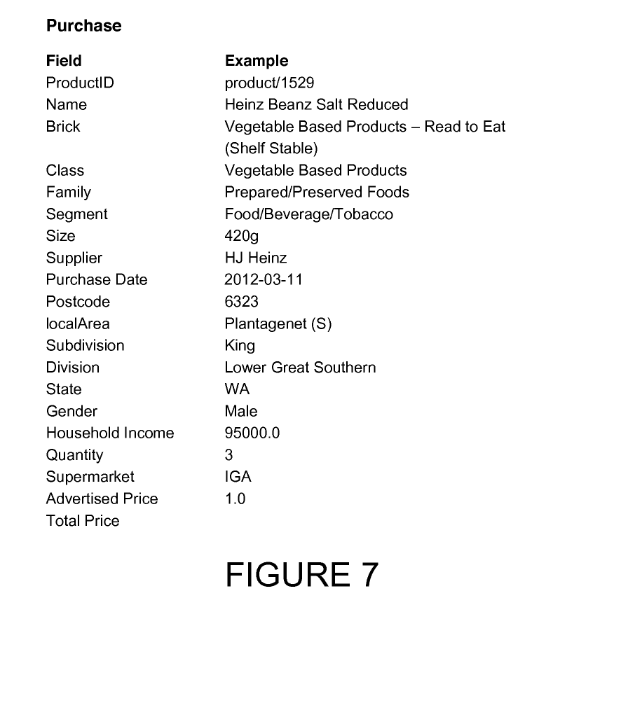

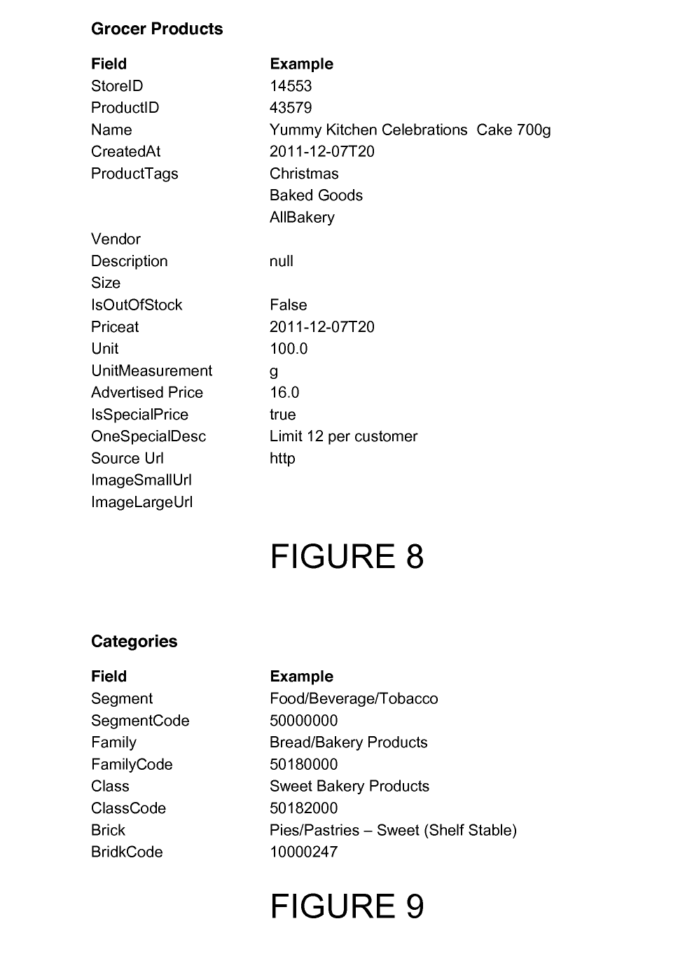

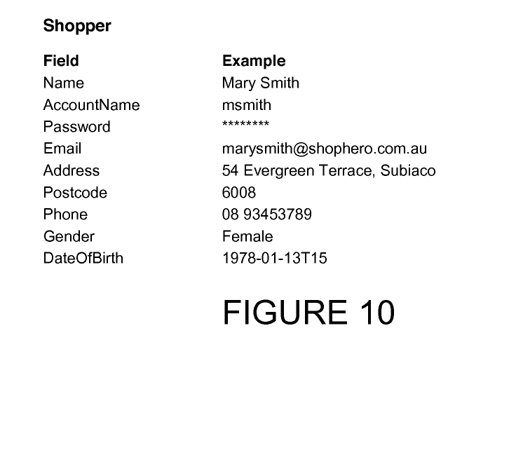

As the platform is database driven, it is straight forward for it to keep a record of all transactions undertaken through it. FIGS. 5 to 10 illustrate critical data tables that exist in the database schema design. These figures are not intended to illustrate all the data tables that will exist in the platform and those skilled in the area if database management will recognize that many other tables will be required within the database and alternative table structure and fields may be equally applicable. The tables shown merely indicate the variety of information that will be available from the platform. Those skilled will recognize the complexity and depth of marketing reports that may be generated from this information. In particular, the ability to match pricing and location of purchases to this degree is unique. Such report will provide invaluable tools to Suppliers and Grocers.

The online shopping platform of the embodiment provides customers with convenience and best price online for their area. Preferably barcode scanning means as previously discussed is provided to each customer so that items are scanned at time of purchase, products are shown and quantity is selected. Because the platform will have scraped major online chains for their prices for products in the area, the customer is provided with the lowest price for the shopping basket. Customers are therefore delivered the best online price available with the convenience of merely scanning the item in front of a device.

The platform:
provides customers with a large selection of online grocery items;
enables customers to easily add items to a shopping list and bring up detailed information via scanning the barcode of a product;
enables customers to easily search for, find, and buy the items they want;
makes buying more convenient by allowing customers to buy items:
   anytime (i.e., 24 hours a day and 7 days a week).
   anywhere the customers have access to the Internet (e.g., at home, at work, and while traveling);
enables customers to minimize the price of a basket items they wish to buy (e.g., via price comparisons).

The platform is an internet-based grocery marketplace bringing together private individuals and presenting them with a choice and pricing for products available for online purchase through grocery retailers. The platform allows product suppliers to directly advertise to potential shoppers and gain insight into the buying choices. The platform provides suppliers with a huge customer base of potential buyers and enables suppliers to easily target and personalize their marketing and advertising to appropriate potential buyers.

The platform provides benefits to Grocers because they can become involved with online sales and be given sales from actual buyers without the need to establish their own online system. It also enables Grocers to market to customers in their area in a targeted and personalized manner and compete with major competitors without the expense of them monitoring competitors prices in their area.

For the Operator, the platform builds a huge customer base of potential buyers, maximise income by maximizing the number of suppliers paying advertising and placement fees and maximises income by providing Grocers “Price Match” services for fees.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

1. An online shopping platform controlled by an Operator and being adapted for repetitive purchases by Customers of a plurality of products of a class from a Grocer designated by the Operator, the platform comprising a computer system having database facilities and being connected to the Internet, wherein the platform maintains a list of products available for purchase from selected major retailers and wherein a price of each product being offered by the selected major retailers is ascertained and recorded on a recurring basis to thereby determine a lowest price for each product within an identified region in order to offer products to Customers located in particular identified regions a price-matched price not higher than the lowest price being offered by any of the selected major retailers in that particular identified region.

2. An online shopping platform as claimed in claim 1 wherein the Grocer charges a delivery charge not more than the delivery charge of the selected major retailers.

3. An online shopping platform as claimed in claim 2 wherein a right to sell products to customers in a particular identified region at the price-matched price for that region is provided to the designated Grocer for a fee for a predetermined period.

4. An online shopping platform as claimed in claim 3 wherein the designated Grocer is provided with an order list and payment by the platform after an order is placed by a customer in the particular identified region.

5. An online shopping platform as claimed in claim 1 wherein a right to market alternative products similar to certain products selected by a Customer is provided to a Supplier for pre-determined period for a fee.

6. An online shopping platform as claimed in claim 5 wherein the Supplier identifies products of its competitors listed on the platform and links Supplier's products to the competitors' products to enable the platform to offer the Supplier's products for sale to a customer when the customer selects a competitor's product.

7. An online shopping platform as claimed in claim 1 wherein the platform stores a record of all purchases by customers in the database to customer purchasing information to be obtained by analysis of the customer's purchases.

8. An online shopping platform as claimed in claim 7 wherein the customer purchasing information is used to enable marketing reports for a particular identified region to be generated and provided to Suppliers and Grocers.

9. An online shopping platform as claimed in claim 7 wherein the customer purchasing information is used to enable Suppliers to direct advertisements to customers in a targeted and personalized manner.

10. An online shopping platform as claimed in claim 7 wherein the customer purchasing information is used to enable Grocers to direct advertisements to customers in a targeted and personalized manner.

11. An online shopping platform as claimed in claim 1 wherein the customer identifies the product to be selected for purchase by scanning the barcode of a same product which the customer has obtained previously.

12. An online shopping method adapted for repetitive online purchases by Customers of products of a class wherein a Customer accesses an online shopping platform and selects one or more products for purchase, the platform being controlled by an Operator, the platform comprising a computer system having database facilities and being connected to the Internet, wherein the platform maintains a list of products available for purchase from selected major retailers and wherein a price of each item being offered by the selected major retailers is ascertained and recorded on a recurring basis to thereby determine a lowest price for each product within an identified region in order to offer products to Customers located in particular identified regions a price-matched price not higher than the lowest price being offered by any of the selected major retailers in that particular identified region and wherein the price-matched price is displayed for viewing by the customer for the products selected wherein the customer completes the purchase and pays for the purchase by payment means, and wherein the selected products are provided to the Customer by a designated Grocer within the particular identified region, the Grocer being selected by the Operator for agreeing with the Operator to provide the products to customers at the price-matched price.

13. An online shopping method as claimed in claim 12 wherein a right to sell products to customers in a particular identified region at the price-matched price for that region is provided to a designated Grocer for a fee for a predetermined period.

14. An online shopping method as claimed in claim 13 wherein the designated Grocer is provided with an order list and payment by the platform after an order is placed by a customer in the particular identified region.

15. An online shopping method as claimed in claim 12 wherein a right to market alternative products similar to certain products selected by a Customer is provided to a Supplier for pre-determined period for a fee.

16. An online shopping method as claimed in claim 15 wherein the Supplier identifies products of its competitors listed on the platform and links Supplier's products to the competitors' products to enable the platform to offer the Supplier's products for sale to a customer when the customer selects a competitor's product.

17. An online shopping method as claimed in claim 12 wherein the platform stores a record of all purchases by customers in the database to customer purchasing information to be obtained by analysis of the customer's purchases.

18. An online shopping method as claimed in claim 17 wherein the customer purchasing information is used to enable marketing reports for a particular identified region to be generated and provided to Suppliers and Grocers.

19. An online shopping method as claimed in claim 17 wherein the customer purchasing information is used to enable Suppliers to direct advertisements to customers in a targeted and personalized manner.

20. An online shopping method as claimed in claim 17 wherein the customer purchasing information is used to enable Grocers to direct advertisements to customers in a targeted and personalized manner.

21. An online shopping method as claimed in claim 12 wherein the customer identifies the product to be selected for purchase by scanning the barcode of a same product which the customer has obtained previously.

22. An online shopping method as claimed in claim 12 wherein the Grocer may charge a delivery charge not more than the delivery charge of the selected major retailers.
